(19) United States
(12) Patent Application Publication
(10) Pub. No.: US 2017/0271906 A1
(43) Pub. Date: Sep. 21, 2017

(54) MOBILE CHARGING MODULE OF WEARABLE ELECTRONIC DEVICE

(71) Applicant: INPAQ TECHNOLOGY CO., LTD., Miaoli County (TW)

(72) Inventors: Ming-Tsan TSENG, Tainan City (TW); Yu-Cheng HAN, Taoyuan City (TW); Chi-Feng YANG, Zhubei City (TW)

(21) Appl. No.: 15/071,420

(22) Filed: Mar. 16, 2016

(51) Int. Cl. H02J 7/02; H02J 9/06

(52) U.S. Cl. CPC H02J 7/025; H02J 9/061

(57) ABSTRACT

A mobile charging module of a wearable electronic device is disclosed. The wearable electronic device includes a main body portion and a lacing portion that can be assembled to or disassembled from the main body portion, wherein the main body portion includes a host, a host battery and a Rx Coil; the lacing portion includes a Tx Coil which can be wireless and inductively charged with the Rx Coil and a backup power supply (BPS); which is characterized in: the Tx Coil and the Rx Coil are mounted on a magnetic body respectively; through controlling a coupling gap between the two magnetic bodies, the magnetic field of the Tx Coil can be coupled to the Rx Coil through the two magnetic bodies for quickly charging the host battery with high efficiency.

### BACKGROUND OF THE INVENTION

Field of the Invention

The present invention relates to a wearable electronic device, particularly to a host battery of a wearable electronic device, which can be charged by converting the ultra-high coupled energy through two magnetic bodies on which a Tx Coil and an Rx Coil are mounted respectively for fast charging.

Description of the Related Art

As technology advances, electronic products are developed towards multi-function, fast operation and small size. The prevalence and popularity of handheld devices such as mobile phones significantly enhance the convenience of people's lives. The development and advent of wearable devices, whether in study, work, leisure, or health care, further provide a more complete convenience and immediacy.

The wearable devices currently developed are mainly in the form of watches. Besides functions such as calling and answering the phone and network on the watch-type wearable device, instant feedback and reaction to human health is the key to promoting more people to use wearable devices. However, due to limited internal space of wearable devices, the capacity of a battery mounted thereon is also limited. Thus, wearable devices cannot be used for a long time. Although the industry has proposed the idea of wireless charging, as the magnetic field of a conventional coil is coupled to a Rx Coil through the air, and the permeability of air is low, the problem of unable to charge quickly and immediately still exists.

In view of the aforementioned shortcomings with regards to the wearable device, after a long period of research in conjunction with improvement on the aforementioned deficiency, the present invention is eventually presented by the inventor.

### SUMMARY OF THE INVENTION

Accordingly, an objective of the present invention is to provide a mobile charging module of a wearable electronic device, wherein a host battery of the wearable electronic device can be charged quickly if the magnetic field is coupled to the Rx Coil through the magnetic circuit material whose permeability (μ) is greater than or equal to 1 to achieve fast charging.

According to the mobile charging module of the wearable electronic device in the present invention, the main body portion includes a host, a host battery and an Rx Coil, wherein the Rx Coil is mounted on a magnetic body. Also, a charging module is provided in a lacing portion that can be disassembled from or assembled to the main body portion. The charging module includes a Tx Coil and a backup power supply (BPS). The Tx Coil is also mounted on a magnetic body. The Tx Coil and the Rx Coil are coupled to each other through the two magnetic bodies for charging with high efficiency.

According to the mobile charging module of the wearable electronic device in the present invention, the magnetic field is coupled to a Rx Coil through the magnetic circuit material whose permeability (μ) is greater than or equal to 1 for charging, which ensures high charging efficiency. According to the circuit function, the number of coil group for the Tx Coil and the Rx Coil may be 1−N.

According to the mobile charging module of the wearable electronic device in the present invention, a charging module is further provided in the charging module within the lacing portion that can import electricity through a local communication line. The backup power supply (BPS) is a flexible thin film battery which can be connected to the charging module to save power or save power through the induction of wireless charging.

According to the mobile charging module of the wearable electronic device in the present invention, the coupling type of the two magnetic bodies on which the Tx Coil and the Rx Coil are mounted respectively may be a semi-circular magnetic body, a spacer type magnetic body, a upper and lower plate magnetic body, or a one-to-many coupling type for use with a variety of wearable electronic devices.

The detailed structure, application principles, functions and effectiveness of the present invention will be apparent with reference to the following description in conjunction with the accompanying drawings.

### BRIEF DESCRIPTION OF THE DRAWINGS

FIG. 1 is a perspective view of a wearable electronic device according to the present invention;

FIG. 2 is a plan exploded view of a mobile charging module of the wearable electronic device according to the present invention;

FIG. 3 is an enlarged assembled view of FIG. 2;

FIG. 4 shows a waveform of a combination of air gap wave-Rx Coupling coefficient −Tx inductance (uH) of a Tx Coil and a Rx Coil in the mobile charging module of the wearable electronic device according to the present invention;

FIG. 5 is a schematic view showing the connection of spacer type magnetic bodies of the mobile charging module of the wearable electronic device according to the present invention;

FIG. 6 is a schematic view showing the connection of upper and lower plate magnetic bodies of the mobile charging module of the wearable electronic device according to the present invention; and

FIG. 7 is a schematic view showing the connection of multiple sets of magnetic bodies of the mobile charging module of the wearable electronic device according to the present invention.

### DETAILED DESCRIPTION OF THE PREFERRED EMBODIMENT

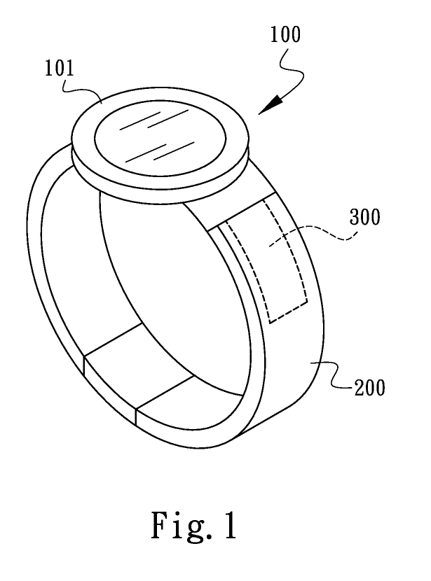

As to a mobile charging module of a wearable electronic device according to the present invention, as shown in FIG. 1, the wearable electronic device 100 includes a main body portion 101 and a lacing portion 200 that can be assembled to or disassembled from the main body portion. The main body portion 101 includes a host with calculation, display, network, or other transmission capabilities. Through the lacing portion 200, the wearable electronic device can be worn and secured to wrist, arm or other parts of the body to facilitate the user to carry and use. A charging module 300 is provided within the lacing portion 102.

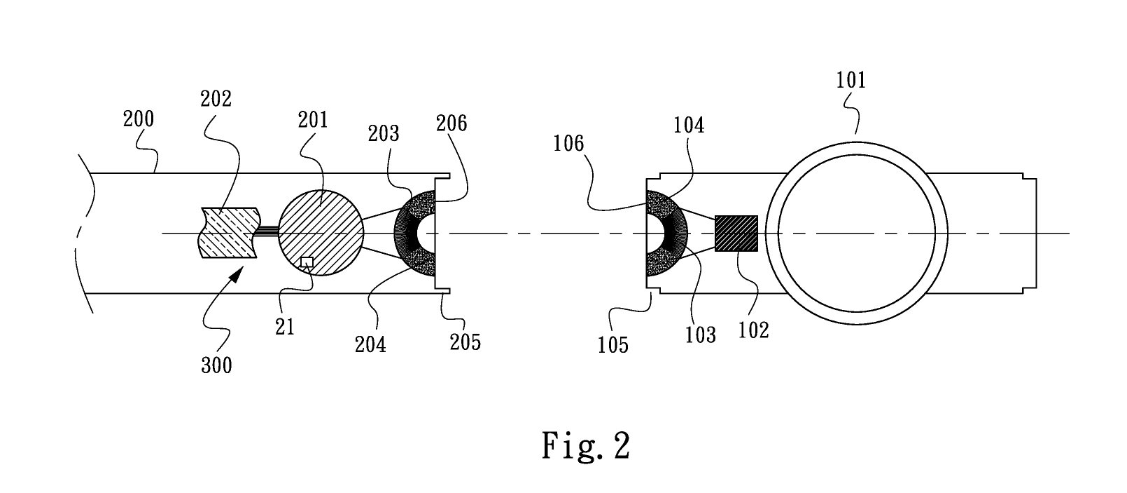

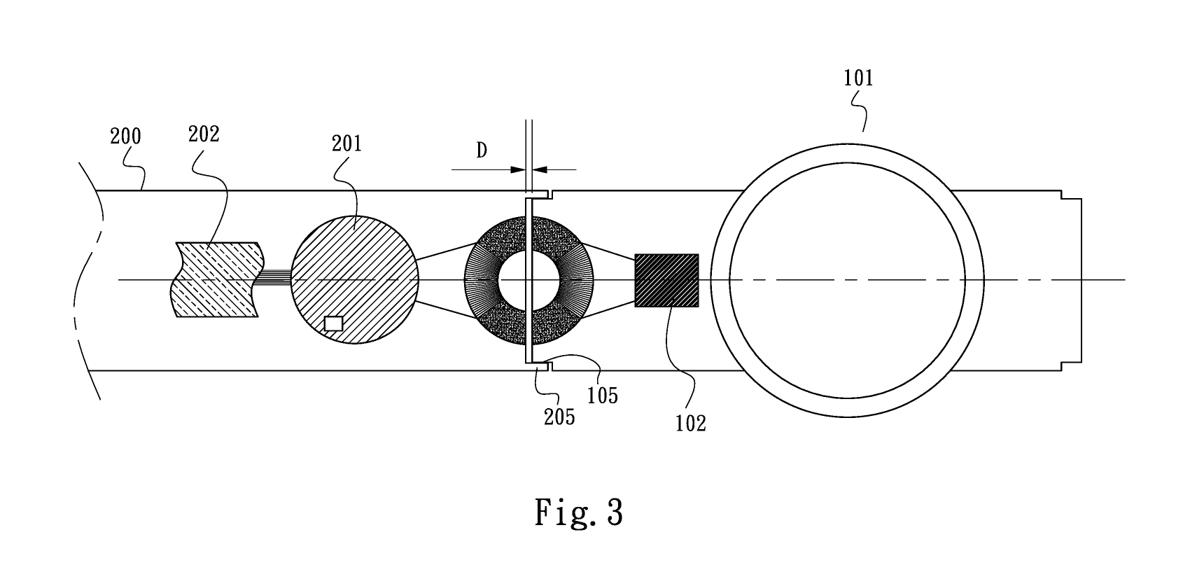

Please refer to FIGS. 2 and 3. The inside of the main body portion 101 of the wearable electronic device 100 is provided with a host battery 102 that supplies power to the host, and a Rx Coil 103 connected to the host battery 102. The Rx Coil 103 is mounted on a semi-circular magnetic body 104. Also, both sides of the main body portion 101 are provided with connecting portions 105 that can be assembled to the lacing portion 200. A coupling face 106 of the magnetic body 104 on the Rx Coil 103 is located at the front end of the connecting portion 105.

As shown in FIGS. 2 and 3, the charging module 300 within the lacing portion 200 includes: a charging module 201, a flexible thin film battery 202 served as a backup power supply (BPS), and a Tx Coil 203. Specifically, a connection contact point 21 provided on the charging module 201 imports electricity to the Tx Coil 203 and the flexible thin film battery 202 through the local communication line. Also, the Tx Coil 203 is mounted on a semi-circular magnetic body 204.

As shown in FIGS. 2 and 3, two ends of the lacing portion 200 are provided with an engaging portion 205 that can be connected and assembled to the connecting portion 105 of the main body portion 101. The coupling face 206 of the magnetic body 204 on which the Tx Coil 203 is mounted is located at the front end of the engaging portion 205.

Accordingly, when the engaging portion 205 of the lacing portion 200 is assembled to the connecting portion 105 of the main body portion 101 relative to each other, the coupling face 206 of the magnetic body 204 on which the Tx Coil 203 is mounted is opposite to the coupling face 106 of the magnetic body 104 on which the Rx Coil 103 is mounted, while keeping a coupling gap D for performing a ultra-high performance coupled conversion and charging. The electric power of the flexible thin film battery 202 can be coupled to the Rx Coil 103 and the magnetic body 104 on which the Rx Coil 103 is mounted through the Tx Coil 203 and the magnetic body 204 on which the Tx Coil 203 is mounted such that the host battery 102 can be quickly charged.

The wiring of the Tx Coil 203 or Rx Coil 103 may be FPC copper wire or other types. The magnetic field of the Tx Coil 203 can be coupled to the Rx Coil 103 through the magnetic circuit material whose permeability (μ) is greater than or equal to 1 for charging. This can indeed achieve high efficiency charging. According to the electronic circuit function, the number of coil group on the Tx Coil 203 and the Rx Coil 103 may be 1−N.

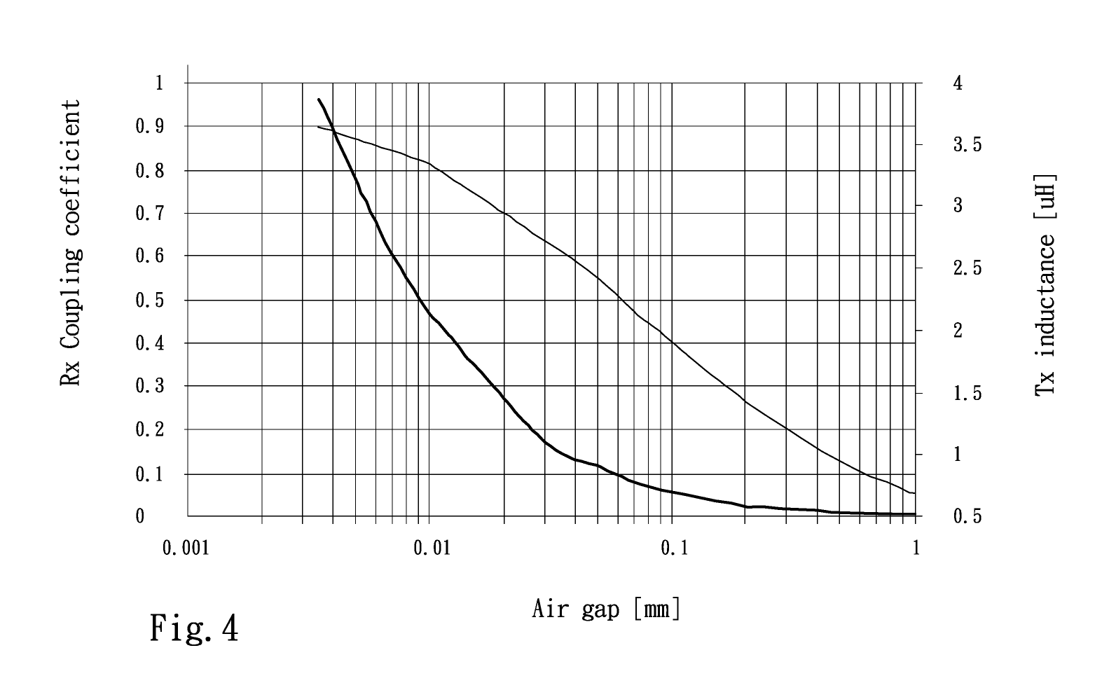

Please refer to FIG. 4. The coupling gap D of the magnetic body 24 on which the Tx Coil 203 is mounted and the magnetic body 104 on which the Rx Coil 103 is mounted (e.g. a combination of air gap as shown in FIG. 4) is proportional to the inductance (uH) of the Tx Coil 203 and the coupling coefficient of the Rx Coil 103. When the distance of the gap D is about 0.005 mm, the coupling coefficient of the Rx Coil and the inductance (uH) of the Tx Coil are the highest. When the distance of the gap D is about 1 mm, the coupling coefficient of the Rx Coil and the inductance (uH) of the Tx Coil are the lowest. Accordingly, through controlling the gap between two magnetic bodies of the Tx Coil and the Rx Coil, the efficiency of converting the ultra-high coupled energy can be adjusted. Also, the coupling gap may be greater than or equal to 0 mm.

According to the mobile charging module of the wearable electronic device in the present invention, through providing a charging module 300 within the lacing portion 200 that can be assembled to or disassembled from the main body portion 101, the necessary electrical power of the host battery 102 of the main body portion 101 in the wearable electronic device can be supplied at any time. Users can prepare multiple sets of fully charged lacing portion 200. Once the electric power of the host battery 102 in the main body portion 101 drops, the user can just replace a previously fully charged lacing portion 200. Once the lacing portion 200 is connected to the main body portion 101, the Tx Coil 203 can be coupled to the Rx Coil 103 through the magnetic circuit material whose permeability (μ) is greater than or equal to 1 to quickly charge host battery 102. Therefore, a host of the main body portion 101 may continue to be used while adequate electrical power is kept.

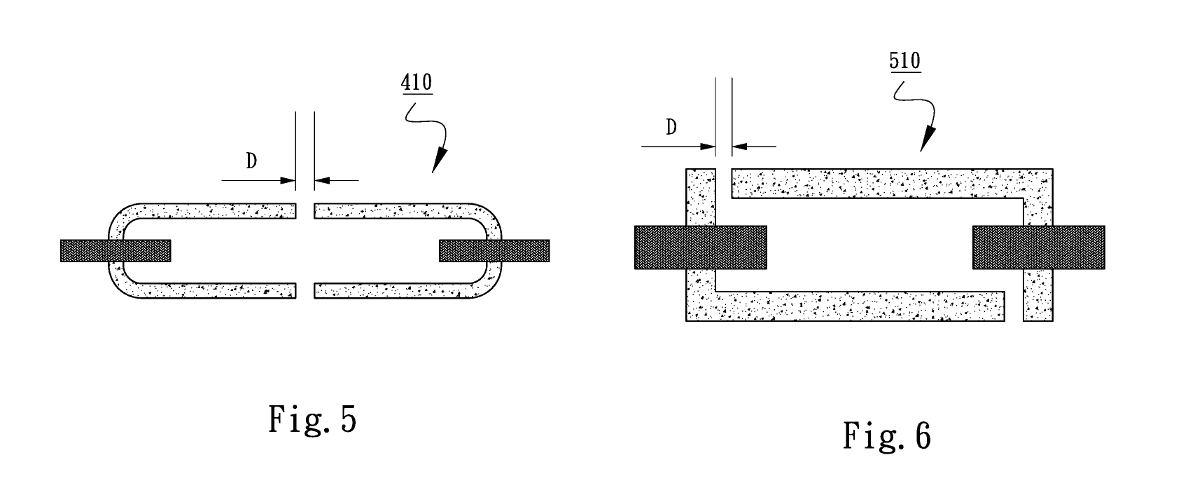

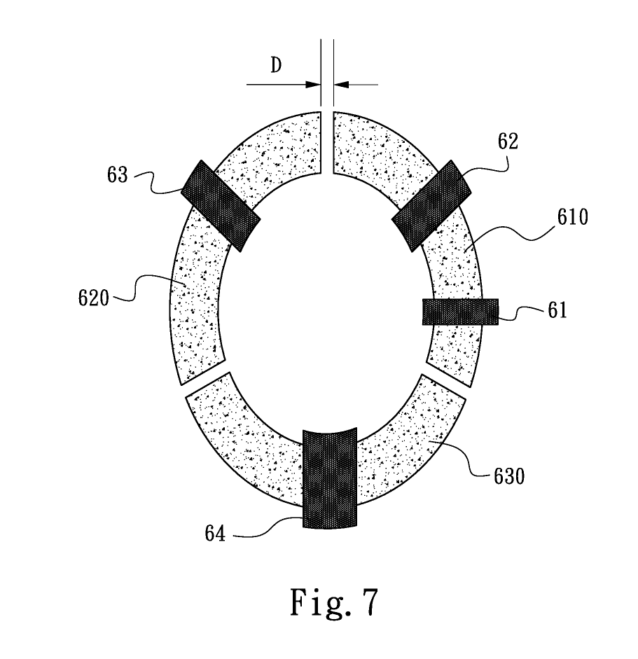

According to the mobile charging module of the wearable electronic device in the present invention, the two magnetic bodies on which the Tx Coil and the Rx Coil are mounted respectively, with the coupling gap D therebetween, are not only a semi-circular body, but can be adjusted to be used according to different types of wearable electronic devices (e.g. smart watches, fitness monitoring devices, disabling monitoring devices, etc.). For example, the magnetic bodies may be in the form of a ⊂-shaped spacer type magnetic body 410 whose left and right are coupled to each other as shown in FIG. 5, or a L-shaped upper and lower plate magnetic body 510 whose upper and lower part are coupled to each other as shown in FIG. 6, or a one-to-many coupling type as shown in FIG. 7 formed by arranging a Tx Coil 61 and a plurality of Rx Coils 62, 63, 64 on a plurality of magnetic bodies 610, 620, 630 in a circular shape.

As described above, the mobile charging module of the wearable electronic device according to the present invention enables the Tx Coil to be coupled to the Rx Coil through the magnetic circuit material whose permeability (μ) is greater than or equal to 1 to achieve fast charging, which ensures the main body of the wearable electronic device to have sufficient power for use at any time. This is not disclosed and used in public, and is compliant with provisions of the Patent Law. It would be appreciated if the committee could kindly approve and grant a patent earlier for the benefit of society.

It should be noted that the described are preferred embodiments, and that changes and modifications may be made to the described embodiments without departing from the scope of the invention as disposed by the appended claims.

What is claimed is:

1. A mobile charging module of wearable electronic device, wherein the wearable electronic device comprises a main body portion and a lacing portion that can be assembled to or disassembled from the main body portion, wherein the main body portion comprises a main body, a host battery, and a Rx Coil; the lacing portion comprises a charging module which includes a Tx Coil and a backup power supply (BPS); which is characterized in: the Tx Coil and the Rx Coil are mounted on a magnetic body respectively; through controlling a coupling gap between a coupling face of two magnetic bodies, the magnetic field of the Tx Coil can be coupled to the Rx Coil through two magnetic bodies for quickly charging the host battery with high efficiency.

2. The mobile charging module of wearable electronic device as claimed in claim 1, wherein the magnetic field of the Tx Coil is coupled to the Rx Coil through the magnetic circuit material whose permeability (μ) is greater than or equal to 1 for charging; according to the electronic circuit function, the number of coil group on the Tx Coil and the Rx Coil may be 1−N.

3. The mobile charging module of wearable electronic device as claimed in claim 1, wherein the charging module further comprises a charging module capable of importing electricity through the local communication line, the charging module being connected to the Tx Coil and the backup power supply (BPS) respectively.

4. The mobile charging module of wearable electronic device as claimed in claim 1, wherein the backup power supply (BPS) is a flexible thin film battery.

5. The mobile charging module of wearable electronic device as claimed in claim 4, wherein the flexible thin film battery can be charged through wireless charging.

6. The mobile charging module of wearable electronic device as claimed in claim 1, wherein the magnetic body on which the Tx Coil is mounted and the magnetic body on which the Tx Coil is mounted may be coupled to each other in the form of a semi-circular magnetic body, a ⊂-shaped spacer type magnetic body, a L-shaped upper and lower plate magnetic body, or one-to-many coupling type formed by arranging a Tx Coil and a plurality of Rx Coils on a plurality of magnetic bodies in a circular shape.

7. The mobile charging module of wearable electronic device as claimed in claim 6, wherein the coupling gap between the magnetic body of the Rx Coil and the Tx Coil is proportional to the coupling coefficient of the Rx Coil and the inductance (uH) of the Tx Coil.

8. The mobile charging module of a wearable electronic device as claimed in claim 1, wherein the coupling gap may be greater than or equal to 0 mm.
